(19) United States
(12) Patent Application Publication
(10) Pub. No.: US 2012/0253691 A1
(43) Pub. Date: Oct. 4, 2012

(54) TESTING A HUMIDITY SENSOR

(76) Inventors: Markus Graf, Zurich (CH); Christoph Schanz, Stafa (CH)

(21) Appl. No.: 13/415,284

(22) Filed: Mar. 8, 2012

(30) Foreign Application Priority Data
Apr. 4, 2011 (EP) 11002800.8

(51) Int. Cl. G06F 19/00

(52) U.S. Cl. 702/24

(57) ABSTRACT

A relative humidity of the environment of a humidity sensor is measured by the humidity sensor twice at different temperatures. For both measurements, a corresponding value based on a saturated vapour pressure at the subject temperature is calculated. The two calculated values derived are then evaluated. The evaluation result allows for a conclusion if the humidity sensor may be impaired in its capabilities of measuring humidity.

### CROSS REFERENCE TO RELATED APPLICATIONS

This application claims the priority of European patent application 11 002 800.8, filed on Apr. 4, 2011, the disclosure of which is incorporated herein by reference in its entirety.

### BACKGROUND OF THE INVENTION

The invention relates to a method for testing a humidity sensor, a corresponding computer program element, and to an arrangement for testing a humidity sensor.

Humidity sensors are used in many different applications. What is common to nearly all the applications is that for the reason that the relative humidity in the environment of the sensor shall be detected, a sensitive element of such humidity sensor needs to be exposed to the environment for allowing sufficient access of the medium/the air containing the humidity to such sensitive element. However, the environment may contain chemical substances affecting the capability of the sensitive element to absorb humidity as required for precise measurements.

In EP 1 236 038 B1, a humidity sensor is disclosed with interdigital electrodes being arranged on a substrate. A sensitive layer, for example a polymer layer, is deposited on the substrate and covers the electrodes. The polymer layer is susceptible to humidity. Humidity absorbed by the polymer layer changes the dielectric constant of the polymer layer such that a capacity between the electrodes represents a measure for the relative humidity of the environment.

### BRIEF SUMMARY OF THE INVENTION

Hence, it is a general object of the invention to provide a test for a humidity sensor which test allows for a conclusion if the humidity sensor is impaired in its capabilities of measuring humidity.

This problem is solved by a method for testing a humidity sensor according to the features of independent claim 1.

According to this method, a relative humidity is measured by the humidity sensor twice at different temperatures. For both measurements, corresponding values are calculated. These values are then evaluated. The evaluation result allows for a conclusion if the humidity sensor may be impaired in its capabilities of measuring humidity.

The present idea makes use of the characteristics of a saturated vapour pressure at the different temperatures measured. There may be different ways for calculating values that combine the saturated vapour pressure with the relative humidity as measured. One preferred way is to determine a dew point for each measurement, a formula for such dew point being dependent on the measured relative humidity and the saturated vapour pressure at the measured temperature. Another preferred way is to determine an absolute humidity for each measurement, a formula for such absolute humidity being dependent on the measured relative humidity and the saturated vapour pressure at the measured temperature.

For the embodiment of the dew point representing the value being evaluated the following section may provide a reasoning why the above method may support the detection of impaired humidity sensors.

The dew point denotes a temperature to which air needs to be cooled down in order to make vapour inherent in the air change its state into liquid water. This means that the dew point typically denotes a temperature below the current temperature. However, when the dew point is equal to the current temperature, the air is fully saturated by humidity.

The relative humidity which can be measured by appropriate humidity sensors denotes the ratio of a current saturation of air with humidity relative to a maximum saturation of air with humidity. The relative humidity is dependent on the temperature. When the temperature increases, the capability of air to absorb additional humidity increases. However, this results in a decrease of the relative humidity since the current saturation of the air now is put into relation with a maximum saturation that is higher than before. As a result, with rising temperatures the relative humidity decreases, while with temperatures dropping the relative humidity rises.

Formulas for calculating the dew point are dependent on the temperature and the relative humidity at such temperature. With respect to the above said, the relative humidity itself is dependent on the temperature. For any change in temperature the relative humidity changes into the opposite direction. In effect, for the dew point determination, any change in the temperature shall be irrelevant. Irrespective of the temperature, the dew point remains constant since it denotes the temperature to which the temperature needs to be cooled down for effecting a phase transformation from vapour to water.

However, when the capability of the humidity sensor to absorb humidity is affected, the relative humidity measured may no longer correspond to the real relative humidity in the air. The correlation between the temperature and the relative humidity measured may be modified compared to an unaffected humidity sensor. From a bare measuring of the relative humidity one would not become aware of the impairment of the humidity sensor.

In contrast to the relative humidity, the calculated dew point or any other value dependent on the saturated vapour pressure at the measured temperature and the associated measured relative humidity may be an appropriate indicator for a humidity sensor being affected in its sensing capabilities: Whenever for different temperatures the dew point—or more generally the value determined subject to the measured temperature and the associated measured relative humidity—no longer remains constant but varies, the conclusion may be that the sensing capability of the humidity sensor is affected. In particular, when the dew point calculated for a first relative humidity measured at a first temperature is different from the dew point calculated for a second relative humidity measured at a second temperature, then the humidity sensor may be detected as an affected humidity sensor and may need to be cleaned or replaced, for example.

Summarizing, the present idea is based on the insight that although the relative humidity output by a humidity sensor changes with varying temperature, associated values such as the dew point or the absolute humidity which are calculated based on the measured relative humidity and the temperature do not change for varying temperatures. In case the dew point or another such value changes, this can be taken as an indicator that the humidity sensor is affected and its signal no longer reflects the real relative humidity of the environment.

Varying the temperature of an air volume for which the humidity shall be measured may not be easy to achieve for test purposes. For this reason, it is proposed in a preferred embodiment, that the humidity sensor itself may be subjected to a varying temperature. Heating or cooling the humidity sensor itself may be an appropriate means for the present testing. As a result, it is preferred that the temperature of the humidity sensor is measured. It is preferred, that the temperature sensor is arranged close to the humidity sensor such that the temperature sensor substantially senses the temperature of the humidity sensor itself. In case the humidity sensor is integrated on a substrate, it is preferred to integrate the temperature sensor on this substrate, too. Given that the substrate may have a good thermal conductivity, an arrangement of the heater and the temperature sensor in close vicinity to the humidity sensor on the substrate may provide measuring results substantially representing the temperature of the humidity sensor or at least a strong dependency from such temperature.

According to another aspect of the present invention, a computer program element is provided which may be used in testing a humidity sensor. The computer program element comprises computer program code means for calculating a first value based on a first temperature and a first relative humidity measured by a humidity sensor at the first temperature, calculating a second value based on a second temperature and a second relative humidity measured by the humidity sensor at the second temperature, and comparing the first value with the second value. The first value is based on a saturated vapour pressure at the first temperature, and the second value is based on a saturated vapour pressure at the second temperature.

According to a further aspect of the present invention, an arrangement for testing a humidity sensor is provided. The arrangement comprises the humidity sensor, a temperature sensor, and one of a heater and a cooler. A control unit is adapted for calculating a first value based on a first relative humidity measured by the humidity sensor at a first temperature and based on a saturated vapour pressure at the first temperature which first temperature is measured by the temperature sensor. The control unit is further adapted for calculating a second value based on a second relative humidity measured by the humidity sensor at a second temperature and based on a saturated vapour pressure at the second temperature. which second temperature is measured by the temperature sensor. The control unit is further adapted for comparing the first value with the second value.

Other advantageous embodiments are listed in the dependent claims as well as in the description below.

The described embodiments similarly pertain to the method, the arrangement, and the computer program element. Synergetic effects may arise from different combinations of the embodiments although they might not be described in detail.

Further on, it shall be noted that all embodiments of the present invention concerning a method might be carried out in the order of the steps as described, or, alternatively, in any other order. The disclosure and the scope of the invention shall include any order of steps irrespective of the order listed in the claims.

### BRIEF DESCRIPTION OF THE DRAWINGS

The aspects defined above and further aspects, features and advantages of the present invention can also be derived from the examples of embodiments to be described hereinafter and are explained with reference to examples of embodiments illustrated in the Figures. The Figures show:

FIG. 1 a cut through a schematic testing arrangement according to an embodiment of the present invention,

FIG. 2 a diagram illustrating two dew point characteristics, a first one based on relative humidity measures accomplished with a properly working humidity sensor, and a second one based on relative humidity measures accomplished with an impaired humidity sensor, and

FIG. 3 a diagram illustrating an interrelationship between the dew point, the relative humidity and the absolute humidity,

FIG. 4 to FIG. 9 flow diagrams, each representing a method for testing a humidity sensor according to an embodiment of the present invention.

### DETAILED DESCRIPTION OF THE INVENTION

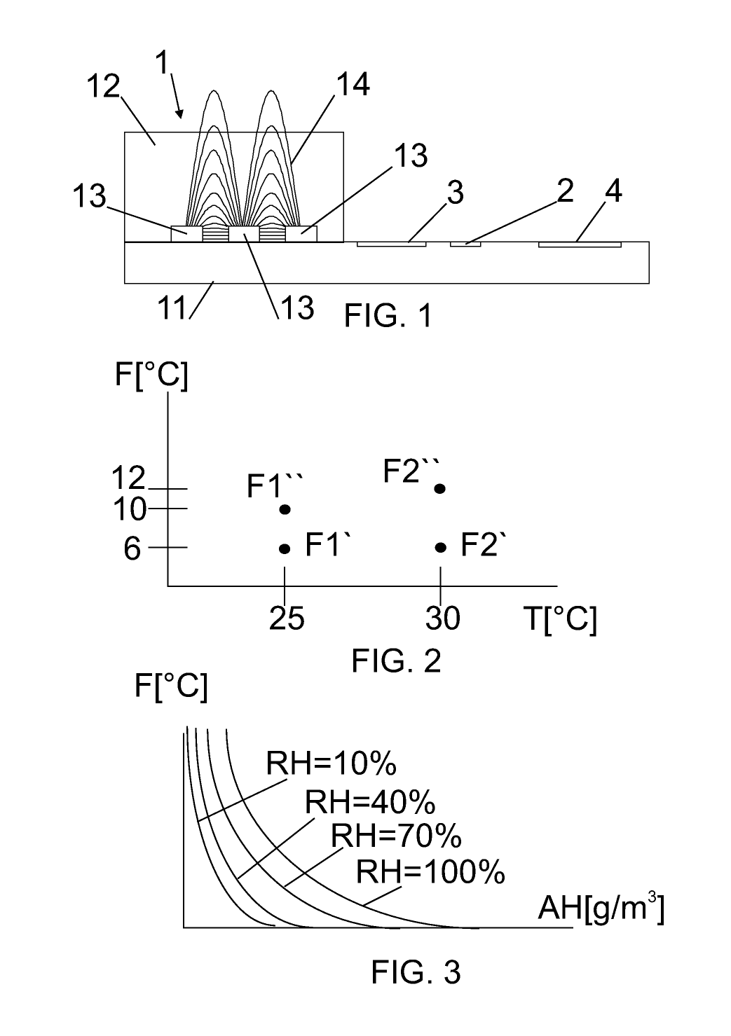

FIG. 1 illustrates a longitudinal cut through a schematic testing arrangement for testing a humidity sensor according to an embodiment of the present invention.

The humidity sensor 1 comprises a substrate 11, electrodes 13 arranged on or integrated into the substrate 11, and a humidity sensitive layer 12 arranged on the substrate 11 covering the electrodes 13. The sensitive layer 12 preferably is a polymer layer or a ceramic layer and is susceptible to humidity. A change in a dielectric constant of the sensitive layer 12 results in a change of a capacitance of the sensitive layer 12. The electrodes 13 are arranged as planar interdigital electrodes for measuring the capacitance of the sensitive layer 12 by means of an electric field indicated by reference numeral 14 penetrating the sensitive layer 12. A signal provided by the electrodes 13 may be taken as a measure for the relative amount of water molecules being absorbed in the sensitive layer 12 reflecting the relative humidity of the air surrounding the test arrangement.

A heater 3 in form of a resistance heater and a temperature sensor 2 are arranged on the same substrate 11 next to the humidity sensor 1. The heater 3 is arranged such that when activated it allows for heating the humidity sensor 1. The temperature sensor 2 is arranged such that it allows for substantially measuring the temperature of the humidity sensor 1. Advantageously, the heater 3 and the temperature sensor 2 are arranged close to the humidity sensor 1, in a preferred embodiment within a radius of 5 mm from the humidity sensor 1, and, in another preferred embodiment, the humidity sensor 1, the temperature sensor 2 and the heater 3 are arranged on the common substrate 11. The heater 3 and the temperature sensor 2 will be used during the testing routine as will be explained later on.

A control unit 4 is schematically illustrated in FIG. 1 as being integrated into the substrate 11 which substrate 11 may preferably be a semiconductor substrate. The control unit 4 may be adapted for testing the humidity sensor 1. The control unit 4 is connected to the humidity sensor 1, the temperature sensor 2, and the heater 3. It is envisaged that the control unit 4 may receive signals indicative of the relative humidity from the humidity sensor 1. For such purpose, additional circuitry may be implemented on the substrate 11, such as an A/D converter, or circuitry with other functionality. The control unit 4 may also receive signals indicative of the current temperature from the temperature sensor 2. The control unit 4 may also be adapted for activating and deactivating the heater 3 when needed. The control unit 4 may be adapted for automatically performing a value determination as explained later on and for initiating associated heating and/or cooling actions and/or measurements such that the control unit may perform a built-in self test of the humidity sensor.

Although the relative humidity output by a humidity sensor changes when the temperature is varied—taking a certain delay time into account—, values based on the saturated vapour pressure at the subject temperature and based on the subject relative humidity are expected to remain constant. A tolerance for a value such as the dew point or the absolute humidity may be set. In case the relevant value is a dew point, for example, an allowed tolerance for such dew point may be at some temperature between 0.5° Celsius and 1° Celsius. Any such tolerance may be set subject to the temperature measured. Whenever the calculated value is rising or falling outside the accepted tolerance after a change in temperature, the humidity sensor can be expected to provide false relative humidity values.

The saturated vapour pressure as a function of the temperature may be given by:

$$e ( T ) = α exp ( \frac{mT}{{T}_{n} + T} )$$

wherein:

e denotes the saturated vapour pressure in Pascal,

T denotes the temperature in ° Celsius,

m denotes a first constant,

Tₙ denotes a second constant, and

α denotes a third constant.

The above formula for the saturated vapour pressure is also known as Magnus formula. Typically, the constant m is set to 17.62, the constant Tₙ is set to 243.12° Celsius and the constant α is set to 6.112 hPa. However, there may be other formulas and/or approximations which may represent the saturated vapour pressure, too.

In a preferred embodiment, the values calculated are dew point values F1 and F1 determined for two different temperatures and two associated measured relative humidity values according to

$$F ( φ , T ) = {T}_{n} \frac{ln ( \frac{φ {exp}^{\frac{mT}{{T}_{n} + T}}}{100 \%} )}{m - ln ( \frac{φ {exp}^{\frac{mT}{{T}_{n} + T}}}{100 \%} )}$$

wherein:

F denotes the dew point in ° Celsius,

Φ denotes the relative humidity in %,

T denotes the temperature in ° Celsius,

m denotes a first constant, and

Tₙ denotes a second constant.

The formula for the dew point is derived from the above Magnus formula. Again, the constant m is set to 17.62, while the constant Tₙ is set to 243.12° Celsius. With these constants m, Tₙ the dew point F remains dependent from the relative humidity Φ and the temperature T, wherein the relative humidity Φ itself is dependent from the temperature T, i.e. Φ=f(T). Note that the relative humidity Φ is rising when the temperature T is falling, and vice versa. Other approximations to determining the dew point and/or the underlying saturation vapour pressure may be used instead, or in addition to the above approximation.

In the present testing arrangement, the relative humidity Φ is measured by the humidity sensor, for example the humidity sensor 1 of FIG. 1. The temperature T for which the humidity sensor 1 provides the associated relative humidity Φ is measured by the temperature sensor 2. It is noted that the measurements of the temperature T and the associated relative humidity Φ advantageously are performed within a time interval in which it can be expected that the temperature T does not change. As a result, a first relative humidity Φ1 is measured as is the corresponding first temperature T1. When entering the values of Φ1 and T1 into the dew point formula a first dew point F1 can be calculated.

Then, the humidity sensor temperature T is modified and as a result the temperature T of the air volume in the close vicinity of the humidity sensor 1 becomes modified, too. In the present example, the temperature T of the humidity sensor 1 is increased by means of the heater 3 of FIG. 1. After a certain time has passed after activation of the heater 3, in which time it can be expected that the temperature of the humidity sensor 1 has changed significantly, the current humidity sensor temperature is measured as second temperature T2, as is the associated second relative humidity Φ2. Again, it is preferred that the measurements of the temperature T and the associated relative humidity Φ are performed in a time interval in which it can be expected that the temperature does not change. When entering both values T2 and Φ2 into the dew point formula a second dew point value F2 can be calculated.

FIG. 2 shows a diagram illustrating two dew point characteristics over temperature T. The first dew point characteristic is represented by the two lower dew points F1′ and F2′ and is based on measurements accomplished with a properly working humidity sensor. A first dew point F1′ at the first temperature T1=25° degrees Celsius is calculated to a value F1′=6° degrees Celsius, and a second dew point F2′ at the second temperature T2=30° degrees Celsius is calculated to a value F2′=6° degrees Celsius which is equal to the first dew point value F1′. For the reason that the dew point for a properly working humidity sensor remains constant irrespective of a change in the temperature T, a conclusion is legitimate that the present humidity sensor is working properly.

The second dew point characteristic is represented by two upper dew points F1″ and F2″ and is based on measurements accomplished with an impaired humidity sensor. The first dew point F1″ at the first temperature T1=25° degrees Celsius is calculated to a value F1″ of 10° degrees Celsius, and the second dew point F2″ at the second temperature T2=30° degrees Celsius is calculated to a value F2″ of 12° degrees Celsius. A deviation between the dew points F″2 and F″1 is two degrees Celsius which is above a sample threshold TH of one degree Celsius which may, in the present embodiment, represent the critical threshold TH for differentiating between a properly working humidity sensor and an impaired humidity sensor.

While in the above example, the dew points themselves were evaluated as critical values for determining if the underlying humidity sensor is impaired, in another preferred embodiment, it generally is value V1 and value V2 being analyzed e.g. by means of forming a deviation |V2−V1| between such values V2, V1, which values V2, V1 are based on the saturated vapour pressures for the subject temperatures.

In a preferred embodiment, such values V1, V2 may represent the absolute humidity AH1, AH2. The absolute humidity AH in [g/m3] is interrelated with the relative humidity—which in this specific example is denoted as RH instead of Φ—in % and the maximum humidity MH in g/m³ by: RH=(AH/MH)*100%.

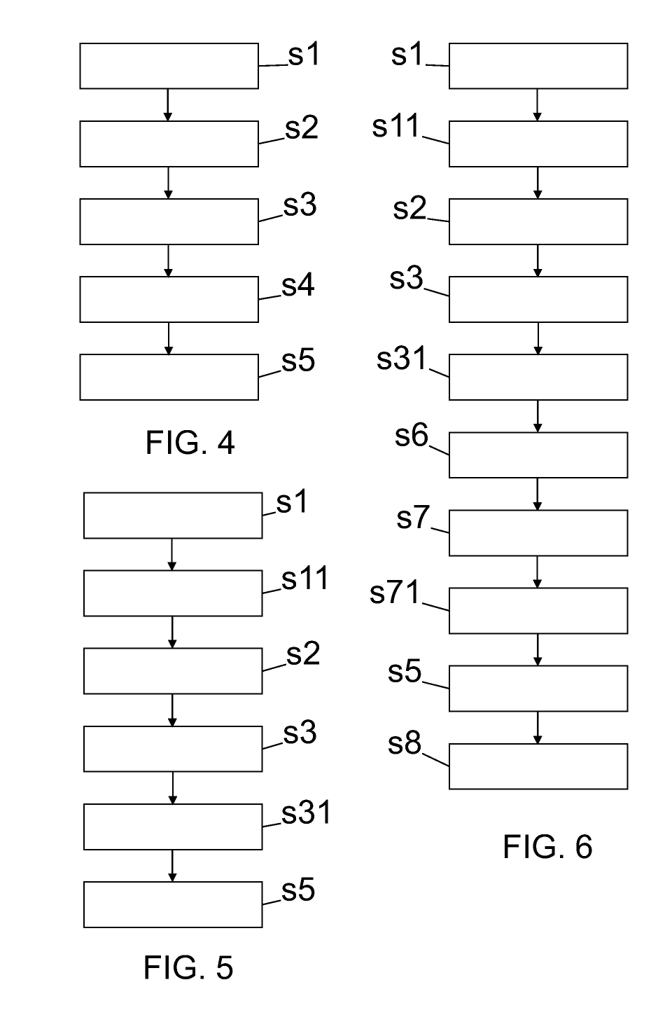

FIG. 3 illustrates a relationship between the dew point F in degrees Celsius, the relative humidity RH in % and the absolute humidity AH in g/m³ in form of a diagram including various characteristics for various relative humidity values RH. When using the absolute humidity AH as differentiator value V, it is preferred that the corresponding dew points F are determined in one of the ways as illustrated above. Then, the absolute humidity AH can be determined by using a diagram such as shown in FIG. 4. The information contained in such diagram may preferably be electronically stored in the test arrangement in form of a look up table within the control unit 4. When having the dew point F calculated subject to a measured relative humidity RH and a measured temperature T, the absolute humidity AH can be determined from such look-table. Determining the absolute humidity AH as the relevant value V to be evaluated finally results in two absolute humidity values AH1 and AH2 to be compared with a threshold TH, i.e. |AH2−AH1|>TH, by means of which term it is determined if the humidity sensor is not working properly or not.

In another embodiment, the absolute humidity AH may be defined by

$$AH ( φ , T ) = μ \frac{{e}_{actual}}{v + T} = μ \frac{ \frac{φ}{100 \%} e}{v + T}$$

with e_{actual} representing the actual vapour pressure e_{actual} with the actual vapour pressure e_{actual} being related to the saturation vapour pressure e by

$${e}_{actual} ( φ , T ) = \frac{φ}{100 \%} e$$

By means of inserting the term for the saturation vapour pressure e in the above equation for the absolute humidity AH, the formula for the absolute humidity AH reads as

$$AH ( φ , T ) = μ \frac{ \frac{φ}{100 \%} α {exp}^{\frac{mT}{{T}_{n} + T}}}{v + T}$$

wherein:

AH denotes the absolute humidity in g/m³,

Φ denotes the relative humidity in %,

T denotes the temperature in ° Celsius,

m denotes a first constant,

Tₙ denotes a second constant,

α denotes a third constant,

μ denotes a fourth constant, and

ν denotes a sixth constant.

Typically, the constant m is set to 17.62, the constant Tₙ is set to 243.12° Celsius, the constant α is set to 6.112 hPa, the constant μ is set to 216.7, and the constant ν is set to 273.15° C. The constant ν converts the formula into ° Celsius measures instead of Kelvin, and the constant μ stems from the ideal gas law and is determined by

$$μ = {M}_{H 2 O} \frac{V}{R}$$

wherein

M_{H2O}=18 g/mol representing the molar weight of water,

R=8.314472 J/mol K

and V representing the volume.

In the following flow diagrams of FIGS. 4 to 9, the same steps are denoted by the same reference numerals across all flow diagrams.

FIG. 4 illustrates a flow diagram representing a method for testing a humidity sensor according to an embodiment of the present invention, preferably based on a testing arrangement as illustrated in FIG. 1. In step s1, the current temperature T1 of the humidity sensor 1 and the current relative humidity Φ1 are measured by the respective sensors wherein both measurements are taken simultaneously, or are sequentially timed such that it can be expected that the temperature T and the relative humidity Φ have not changed between the measurements. The first temperature T1 and the first relative humidity Φ1 are stored in a memory of the control unit 4.

In step s2, the heater 3 is activated. The temperature of the humidity sensor 1 is heated, and after a certain time of heating the elevated temperature of the humidity sensor 1 is measured as second temperature T2. Alternatively, when the temperature may be monitored continuously, the heater 3 may be switched off when a given second temperature T2 is reached. Its value T2 is taken as measured second temperature T2. In the same step s3, a second relative humidity value Φ2 is measured at the second temperature T2. Again, both measurements of T2 and Φ2 are taken simultaneously, or are sequentially timed such that it can be expected that the temperature and the relative humidity have not changed between the measurements. The second temperature T2 and the second relative humidity Φ2 are stored in a memory of the control unit 4.

In step s4, a first dew point F1 is calculated subject to the measured first temperature T1 and the measured first relative humidity Φ1. In the same step s4, a second dew point F2 is calculated subject to the measured second temperature T2 and the measured second relative humidity Φ2.

In step s5, the dew points F1 and F2 are evaluated. Preferably, the dew points F1 and F2 are compared to each other, and a deviation |F2−F1| may be determined. In case the deviation |F2−F1| exceeds a threshold TH which threshold TH may be interpreted as a tolerance, such that |F2−F1|>TH, it can be concluded that the humidity sensor 1 is not working properly. In the same step s5, a signal may be issued when the deviation |F2−F1| exceeds the threshold TH based on which signal an operator of the humidity sensor 1 may replace, clean or otherwise repair the humidity sensor 1.

FIG. 5 illustrates a method according to another embodiment of the present invention, again by means of a flow diagram. The steps s1, s2, s3 and s5 represent the same content as in FIG. 4. For this reason, only the differences with respect to the method illustrated in FIG. 4 are emphasized. The method of FIG. 5 differs from the method in FIG. 4 in that the calculation of the dew point is immediately performed after the measures needed for the respective calculation are taken. Immediately after measuring the first temperature T1 and the first relative humidity Φ1 in step s1, the first dew point F1 is calculated in step s11.

The same holds for step s31, in which immediately after measuring the second temperature T2 and the second relative humidity Φ2 in step s3, the second dew point F2 is calculated.

The dew points F1 and F2 may be stored in some memory of the control unit 4 for a later evaluation in step s5.

In the flow diagram of FIG. 6, the method as illustrated in FIG. 5 is extended by means of confirming the results derived from the first two measurements. The steps s1, s11, s2, s3 and s31 are executed in the same order and represent the same content as in FIG. 5. After having executed the method step s31, the two dew points F1 and F2 are calculated, and the heater still is activated. In subsequent step s6, the heater now is deactivated, and it is waited for a while for allowing the temperature of the humidity sensor 1 to drop back to the level of the first temperature T1 which represents the initial temperature without any impact of heating. At such point in time, the temperature of the humidity sensor 1 for safety reasons is measured again in step s7 as third temperature T3, and an associated third relative humidity Φ3 is measured in the same step 7.

In step s71, a third dew point F3 is calculated based on the measured third temperature T3 and the measured third relative humidity Φ3. In subsequent step s5, the first and the second dew points F1 and F2 may be compared to each other, e.g. by means of evaluating a deviation |F2−F1|. In subsequent step s8, the third and the first dew point F3 and F1 may be compared to each other, e.g. by means of evaluating a deviation |F3−F1|. In case both of the deviations |F2−F1| and |F3−F1| are significant and as such e.g. exceed corresponding thresholds TH, another signal may indicate such scenario to the operator.

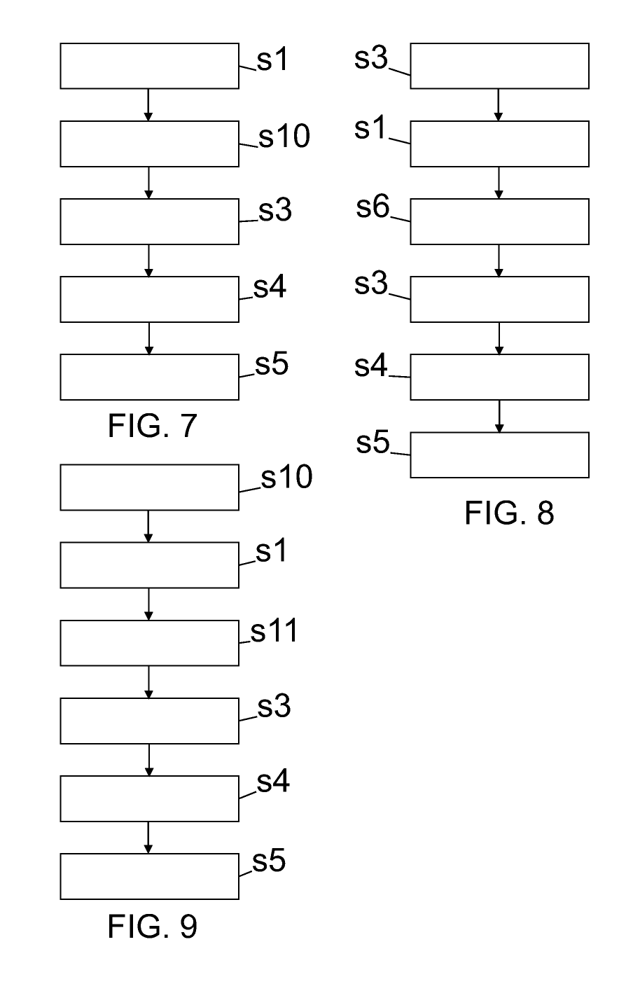

The method of FIG. 7 differs from the method of FIG. 4 in that instead of heating the humidity sensor 1 after having taken the first measurement with respect to relative humidity and temperature, the humidity sensor 1 is cooled down to a temperature lower than the first temperature T1. As a result, the heating step s2 of FIG. 3 is replaced by a cooling step s10. A cooler may be provided in/for the testing arrangement. After a while during which it can be expected that the temperature has dropped significantly, a second temperature T2 is measured which will be lower than the first temperature T1, as will be measured a second relative humidity Φ2 at the second temperature T2, all in step s3. In step s4, the dew points F1 and F2 are calculated and in step s5, the calculated dew points F1 and F2 are evaluated.

The method of FIG. 8 differs from the method of FIG. 4 in that instead of heating the humidity sensor 1 after the first measurements are taken the humidity sensor 1 first is heated in step s3 by means of activating the heater. After a while, the temperature is measured as first temperature T1 in subsequent step s1 as is the first relative humidity Φ1 at such first temperature T1. In subsequent step s6, the heater is deactivated, and after a while, during which it can be expected that the temperature has dropped significantly, and in particular dropped down to the regular temperature without any heating impact, the second measurements are executed in step s3, while the dew points F1 and F2 are calculated in step s4 and the calculated dew points F1 and F2 are evaluated in step s5.

The method of FIG. 9 differs from the method of FIG. 8 in that instead of cooling the humidity sensor 1 after the first measurements are taken the humidity sensor 1 first is cooled in step s10 by means of activating a cooler. After a while, the temperature is measured as first temperature T1 in subsequent step s1 as is the first relative humidity Φ1 at such first temperature T1. In the subsequent step s11, the cooler is deactivated, and after a while, during which it can be expected that the temperature has risen significantly, and in particular risen up to the regular temperature without any cooling impact, the second measurements are executed in step s3, while the dew points F1 and F2 are calculated in step s4, and the calculated dew points F1 and F2 are evaluated in step s5.

It is noted that all formulas may be implemented as look up tables which may be easy to store in a computerized memory. Still, the underlying correlation between input and output variables may follow the underlying equations.

While there are shown and described presently preferred embodiments of the invention, it is to be distinctly understood that the invention is not limited thereto but may be otherwise variously embodied and practised within the scope of the following claims.

1. Method for testing a humidity sensor,
comprising the steps of:
at a first temperature measuring a first relative humidity by the humidity sensor,
calculating a first value based on the measured first relative humidity and based on a saturated vapour pressure at the first temperature,
at a second temperature measuring a second relative humidity by the humidity sensor,
calculating a second value based on the measured second relative humidity and based on a saturated vapour pressure at the second temperature, and
evaluating the first value and the second value relative to each other.

2. Method according to claim 1,
wherein the first value represents a first dew point, and
wherein the second value represents a second dew point.

3. Method according to claim 1,
wherein the first value represents a first absolute humidity, and
wherein the second value represents a second absolute humidity.

4. Method according to claim 1,
wherein the first and the second values are determined from a look-up table.

5. Method according to claim 1,
wherein the first temperature and the second temperature each represent a temperature of the humidity sensor, which temperatures are measured by a temperature sensor arranged together with the humidity sensor on a common substrate.

6. Method according to claim 1,
wherein evaluating the first value and the second value relative to each other includes determining a deviation between the first value and the second value, comparing the deviation with a threshold, and issuing a signal when the deviation exceeds the threshold.

7. Method according to claim 1,
wherein between measuring the first relative humidity and the second relative humidity a heater arranged on a common substrate together with the humidity sensor is activated for increasing the temperature of the humidity sensor.

8. Method according to claim 1,
wherein the saturated vapour pressure is given by
$$e ( T ) = α exp ( \frac{mT}{{T}_{n} + T} )$$
wherein:
e denotes the saturated vapour pressure in Pascal,
T denotes the temperature in ° Celsius,
m denotes a first constant,
Tₙ denotes a second constant, and
α denotes a third constant.

9. Method according to claim 2,
wherein the dew points are calculated based on
$$F ( φ , T ) = {T}_{n} \frac{ln ( \frac{φ {exp}^{\frac{mT}{{T}_{n} + T}}}{100 \%} )}{m - ln ( \frac{φ {exp}^{\frac{mT}{{T}_{n} + T}}}{100 \%} )}$$
wherein:
F denotes the dew point in ° Celsius,
Φ denotes the relative humidity in %,
T denotes the temperature in ° Celsius,
m denotes a first constant, and
Tₙ denotes a second constant.

10. Method according to claim 3,
wherein the absolute humidities are calculated based on
$$AH ( φ , T ) = μ \frac{ \frac{φ}{100 \%} α {exp}^{\frac{mT}{{T}_{n} + T}}}{v + T}$$
wherein:
AH denotes the absolute humidity in g/m³,
Φ denotes the relative humidity in %,
T denotes the temperature in ° Celsius,
m denotes a first constant,
Tₙ denotes a second constant,
α denotes a third constant,
μ denotes a fourth constant, and
ν denotes a sixth constant.

11. Method according to claim 1,
wherein after measuring the first relative humidity and the second relative humidity a third relative humidity is measured by the humidity sensor at a third temperature,
wherein a third value is calculated based on the measured third relative humidity and based on a saturated vapour pressure at the third temperature, and
wherein the third value is evaluated with respect to at least one of the first value and the second value.

12. Method according to claim 7,
wherein after measuring the first relative humidity and the second relative humidity a third relative humidity is measured by the humidity sensor at a third temperature,
wherein a third value is calculated based on the measured third relative humidity and based on a saturated vapour pressure at the third temperature,
wherein the third value is evaluated with respect to at least one of the first value and the second value,
wherein between measuring the second relative humidity and the third relative humidity the heater is deactivated for allowing the temperature to drop.

13. Computer program medium for testing a humidity sensor,
comprising computer program code means for calculating a first value based on a saturated vapour pressure at a first temperature and a first relative humidity measured by a humidity sensor at the first temperature, calculating a second value based on a saturated vapour pressure at a second temperature and a second relative humidity measured by the humidity sensor at the second temperature and comparing the first value with the second value.

14. Arrangement for testing a humidity sensor, comprising
the humidity sensor,
a temperature sensor,
one of a heater and a cooler, and
a control unit adapted for calculating a first value based on a saturated vapour pressure at a first temperature measured by the temperature sensor and a first relative humidity measured by the humidity sensor at the first temperature, calculating a second value based on a saturated vapour pressure at a second temperature measured by the temperature sensor and a second relative humidity measured by the humidity sensor at the second temperature, and comparing the first value with the second value.

15. Arrangement according to claim 14,
wherein the humidity sensor, the temperature sensor and the heater are arranged on a common substrate.

16. Arrangement according to claim 15,
wherein the control unit is arranged on the common substrate,
wherein the substrate is a semiconductor substrate, and
wherein the control unit is adapted to automatically perform the calculation, determination and comparison steps with respect to the values and to initiate associated measurements and heating actions for providing an automated self-test for the humidity sensor.

17. Arrangement according to claim 15,
wherein the control unit is arranged on the common substrate,
wherein the substrate is a semiconductor substrate, and
wherein the control unit is adapted to automatically perform the calculation, determination and comparison steps with respect to the values and to initiate associated measurements and cooling actions for providing an automated self-test for the humidity sensor.
